(19) United States
(12) Patent Application Publication
(10) Pub. No.: US 2003/0165233 A1
(43) Pub. Date: Sep. 4, 2003

(54) Universal tie line adapter

(76) Inventor: Ken Veitch, Kelowna (CA)

Correspondence Address: Orange & Chari, 66 Wellington Street West, Suite 4900, Toronto, ON, M5K 1H6, CA

(21) Appl. No.: 10/086,536

(22) Filed: Mar. 4, 2002

(51) Int. Cl. H04M 1/00; H04M 9/00

(52) U.S. Cl. 379/399.01

(57) ABSTRACT

An tie line adapter for use with a first communication system and a second communication system, the first communication system having a tie line with a first characteristic and the second communication system having a tie line with a second characteristic. The tie line adapter having a first controller for controlling the first characteristic, a second controller for controlling the second characteristic, wherein the first characteristic and the second characteristic are adjusted to match each other to allow communication between the first communication system and the second communication system.

### BACKGROUND OF THE INVENTION

1. Field of the Invention

The present invention relates to transmission networks, more particularly it relates to audio adapters.

2. Description of the Prior Art

Intercom systems (ICS) allow communication between remote parties, and are traditionally found in buildings, land vehicles, water vessels or air vessels. With the advances in technology, upgrades to existing intercom systems may be required and usually involve adding other systems in order to expand the existing intercom system. Traditionally, an audio tie line is used to connect multiple audio controllers and panels together to form an intercom system. The audio controllers provide centralized audio management and control within a communications environment, while the panels provide an interfaces for input and output devices such as microphone or speakers.

Tie lines are normally arranged for two-way calling, and can be used to support voice and/or data. In one example, a tie line may comprise four wires, such that the tie line interface uses one pair of wires for the incoming voice signal and another pair of wires for the outgoing voice signal, whereas a two-wire tie line uses a single pair of wires for both the incoming and outgoing voice signal. This approach is ideal when all the components of a multi-device system are procured from the same original equipment manufacturer (OEM), which assures interoperability of the multiple components. In this case, these components have a standard tie line which is compatible with components from that OEM. However, oftentimes expanding an audio system usually requires combining it with systems from other OEMs. These OEM systems are generally not operable with each other when directly interfaced to one another, since the tie line characteristics of the different OEMs are non-standard. For example, the AMS43 audio controller from Northern Airborne Technology, Canada, has a bi-directional intercom tie line with the following characteristics: 340 mV_{RMS} and an expected load impedance of 2000 Ohms. Whereas, the dB 355-003 audio controller from dB Systems, USA, has a bi-directional intercom tie line with the following characteristics: 800 mV_{RMS} and an expected load impedance of 300 Ohms. If the two systems were coupled together directly, the dB audio controller would overload the NAT audio controller, due to the different tie line power levels, that is, 58 mW and 2 mW to the NAT audio controller and the dB audio controller, respectively. This impedance mismatch distorts the sound quality, changes the frequency response and affects the output line level. A disadvantage of the above example is that the NAT user would hear the dB user very loudly, whereas, the dB user would barely hear the NAT user. Therefore, a NAT system may not be directly interfaced to a dB system due to their proprietary bi-directional or uni-directional ICS tie lines. Ideally, the best operation of all ICS functions is obtained when the components of the intercom systems have similar characteristics.

Yet another disadvantage is that some audio panels that do not support any type of tie line such that these panels may not be directly interfaced with the audio system.

It is an object of the present invention to mitigate or obviate at least one of the above-mentioned disadvantages.

### SUMMARY OF THE INVENTION

In one of its aspects, the present invention provides a tie line adapter for use with a first communication system and a second communication system. The first communication system includes a tie line with a first characteristic and the second communication system includes a tie line with a second characteristic. The tie line adapter includes a first controller for controlling the first characteristic and a second controller for controlling the second characteristic, wherein the first characteristic and the second characteristic are adjusted to substantially match each other to allow communication between the first communication system and second communication system.

In another of its aspects, the present invention provides a method for controlling a plurality of characteristics associated with a first tie line and a second tie line to allow communication between a pair of devices. The method includes the steps of associating the characteristics with input and output parameters of each of the tie lines; adjusting at least one of the input parameters of the first tie line and adjusting at least one of the output parameters of the second tie line, such that there is a substantial match between the characteristics of each of the tie lines to facilitate efficient power transfer between said devices

Advantageously, the present invention allows devices, such as audio controllers, with similar or dissimilar operating characteristics or specifications to interoperate, in an audio system setup. The adapter thus provides a substantially inexpensive way of expanding an audio system without the costs and downtime associated with the replacement of the existing equipment.

### BRIEF DESCRIPTION OF THE DRAWINGS

These and other features of the preferred embodiments of the invention will become more apparent in the following detailed description in which reference is made to the appended drawings, by way of example only, wherein:

FIG. 1 is a transmission network, in a preferred embodiment;

FIG. 2 is a schematic diagram of an adapter;

FIG. 3 is the adapter of FIG. 2 in greater detail;

FIG. 4 is a DSP for adapting an incoming signal of a first characteristic by a to an output signal of a second characteristic;

FIG. 5 is a flow chart outlining the steps for facilitating communication between communication systems; and

FIG. 6 is an adapter in use in another embodiment.

### DESCRIPTION OF THE PREFERRED EMBODIMENTS

Reference is first made to FIG. 1 showing a transmission network, shown generally by numeral 10, in a preferred embodiment. The network 10 includes an input device 12, an output device 14 and a communication system 16 coupled to an adapter 18. The adapter 18 allows the communication system 16 to be easily combined with an audio panel 15 that does not support any type of tie line, by using interfacing the audio panel directly with the adapter 18. The input device 12, the output device 14 and the communication system 16 each have unique characteristics associated with input and output parameters such as impedance, current, voltage and power, among others. The input device 12, such as a microphone, is coupled through an audio panel 15 to the adapter 18 by a balanced line 20, and the output device 14, such as headphones, are also coupled via the audio panel 15 to the adapter 18 by a balanced line 22. Typically, an XLR-type connector is used to implement the balanced line circuitry, the connector includes three pins, one pin connected to a positive signal line, another pin connected to the negative signal line and yet another pin connected to the cable shield. By using balanced line circuitry, the microphone 12 and headphones 14 are substantially less susceptible to RFI (Radio Frequency Interference) and the pickup of the other electrical noise and hum. Typically, in a balanced line 20 or 22, the shield of the cable is connected to ground, and the audio signal exists uniquely between the two lines. Therefore, the complete circuit path travelled by the audio signals is down on the positive line and back on the negative line. Since the audio signal currents are flowing in opposite directions at any given moment in the pair of signal wires, the noise that is common to both is effectively cancelled out (“common mode rejection”).

The communication system 16 includes an audio controller 17 that interconnects components such as speaker 19, headset 21 or microphone 23, as a self contained ICS. In order to interface with the input device 12, the audio controller 17 is coupled to the adapter 18 by a tie line 24, which is preferably formed as a wire-line communication path, but may be formed of a wireless communication path. In a typical embodiment, the communication system 16 is an AMS43 Audio Controller from Northern Airborne Technology (NAT), British Columbia, Canada, which has a NAT-standard bi-directional intercom tie line 24 of 340 mV_{RMS} and expected load impedance of 2000 Ohms.

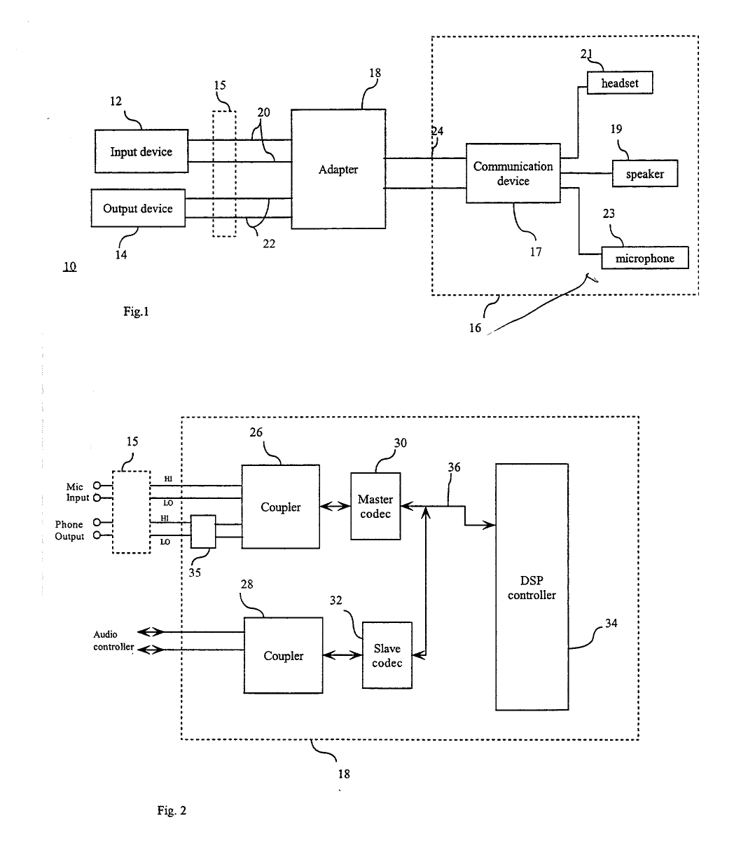

FIG. 2 is a schematic diagram of a universal tie line adapter 18, which comprises a first coupler 26 for interfacing the microphone 12 and the headphones 14 with the adapter 18, and a second coupler 28 for interfacing the communication system 16 with the adapter 18. The input signals and output signals associated with the microphone 12 and the headphones 14 output are connected by the coupler 26 and provided to a master codec 30. Similarly, the input signals and output signals associated with the audio controller 17 output are coupled through the coupler 26 to a slave codec 32. The codecs 30 and 32 (coder/decoder) perform analog-to-digital audio signal conversion or digital-to-analog signal conversion, as will be described in detail below. The digital audio signal from the master codec 30 is introduced into a digital signal processor (DSP) 34 by a digital bus 36. The DSP 34 performs a plurality of functions on the digitized audio signal, such as echo cancelling and filtering to adapt the audio signal for use between the microphone 12, headphones 14 and the audio controller 17. Having been processed by the DSP 34, the digital audio signal is converted back to an analog audio signal and coupled to the audio controller 17 by the coupler 28.

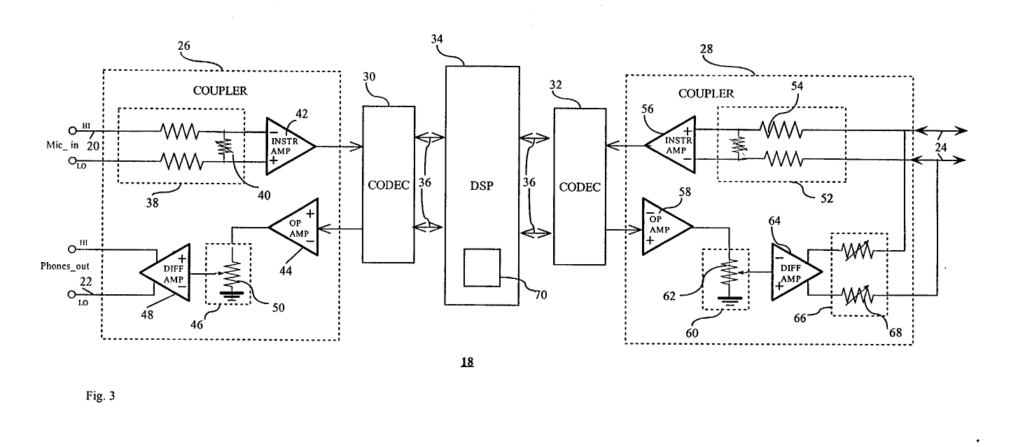

Referring to FIG. 3, the operation of the adapter 18 will now be described in detail. In the input stage of the coupler 26, the input audio signals from the microphone 12 are introduced into the coupler 26 by a balanced line 20, such as a cable. The headphones 14 are also coupled to the coupler 26 by a balanced line 22.

The coupler 26 includes an input signal level controller 38 for adjusting the input signal level. The input signal level controller 38 generally includes a mode select switch 40, typically a variable resistor network, that drops the voltage of the audio signals or attenuates the voltage of the audio signals into an instrumentation amplifier 42, in order to maintain the output voltages within a predefined range. The voltage divider 40 may be implemented as a continuously variable resistor or as a set of different resistive elements in order to drop the voltage of the audio signals in discreet steps, in accordance with the predefined operating characteristics of the well-known OEM audio controllers. As an example, in a preferred embodiment, the microphone input signal level controller 38 provides ten varying steps at its output of 0.5 V_{RMS}, 1.0 V_{RMS}, 2.0 V_{RMS}, 2.5 V_{RMS}, 4.0 V_{RMS}, 4.5 V_{RMS}, 5.5 V_{RMS}, 6.0 V_{RMS}, 8.0 V_{RMS} and 8.5 V_{RMS}, as determined by the resistive elements selectable by the mode select switch 40.

The attenuated balanced input signals are introduced into the instrumentation amplifier 42, which is an AD620 AR instrumentation amplifier from Analog Devices, Norwood, Mass., USA, but may be any other suitable instrumentation amplifier. The instrumentation amplifier 42 senses the difference between the two input signals, and that difference is the desired audio signal. Therefore, that difference is amplified by the instrumentation amplifier 42 to get a single ended output. Thus, the instrumentation amplifier 42 rejects common mode voltages on its inputs over a frequency range in order to keep errors due to on induced noise substantially low. The single ended output is then input into the codec 30 for conversion to digital signals.

The coupler 26 also includes an output stage for processing analog signals from the codec 30. The output stage of the coupler 26, includes an operational amplifier 44, an output level controller 46, and a differential amplifier 48. The codec 30 converts the PCM digital signals from the DSP 34 to analog signals and inputs the signals into the operational amplifier 48 for amplification to meet the requirements of the plurality of the characteristics of the headphones 14. The operational amplifier 44 is a SSM 2135 operational amplifier from Analog Devices, USA, but may be any suitable operational amplifier that can pre-amplify the analog signals.

The output of the operational amplifier 44 is fed into a differential amplifier 48, which converts a single-ended input to a balanced output pair. In a preferred embodiment, the differential amplifier 48 is a DRV 134 differential amplifier from Burr-Brown, Tuscon, Ariz., USA. An output signal level controller 46 adjusts the output level of the operational amplifier 44, and includes a mode select switch 50 operating on a variable resistor network which acts as a voltage divider. Alternatively, a voltage divider 50 may be implemented as a continuously variable resistor or as a mode select switch. The mode select switch 50 selects between different resistive elements in order to drop the voltage of the audio signal in discreet steps, to match the predefined operating characteristics of the well-known OEM audio controllers. As an example, the headphones output signal level controller 46 provides ten adjustment steps, such as 0.25 V_{RMS}, 0.5 V_{RMS}, 1.0 V_{RMS}, 1.25 V_{RMS}, 1,5 V_{RMS}, 1.75 V_{RMS}, 2.25 V_{RMS}, 2.5 V_{RMS}, 2.65 V_{RMS} and 2.8 V_{RMS}, as determined by the resistive elements selectable by the mode select switch 50.

The coupler 26 also includes a pre-emphasis circuit for shaping the lower frequencies of the audio signals in order to minimize the number of taps being transmitted to the codecs 30. The adapter 18 preferably further includes a detector for detecting out-of-band signals from input device 12 and the audio controller 17. The microphone 12 input and the headphones 14 output may include a gain controller 35 to balance the system levels, such as a high gain or a low gain, and thereby enhance the delivery of a substantially balanced performance in the audio system. The input mode select switch 40 enables the input signal to the instrumentation amplifier 42 to be constrained within a predefined range and the output mode select switch 50 likewise permits the output signal to be matched to a range required by the output device 14.

The audio controller 17 is connected to the adapter via the coupler 28. The input stage of the coupler 28 is similar to that of the coupler 26, and includes similar parts with similar functions. The input stage has an input signal level controller 52 for adjusting the input signal level. The input signal level controller 36 generally includes a voltage divider 54, typically a variable resistor network, that drops the voltage of the audio signal or attenuates the voltage of the audio signal into an instrumentation amplifier 56. Similarly, the voltage divider 54 may be implemented as a continuously variable resistor or as a mode select switch. The mode select switch 54 thus selects between different resistive elements in order to drop the voltage of the audio signal in discreet steps, in accordance with the predefined operating characteristics of the well-known OEM audio controllers. Typically, a universal ICS tie input includes an input signal level controller 52 that allows the selection of one of four ICS signal levels, as provided by four separate resistive elements in series with the input of the instrumentation amplifier 40. There may of course be more resistive element choices available. As described above, the instrumentation amplifier 56 senses the differences between the two input signals and amplifies this difference to get a single ended output. Also, the instrumentation amplifier 56 rejects common mode voltages on its inputs over a frequency range in order to keep errors substantially low.

The output stage of the coupler 28 includes an operational amplifier 58, an output signal level controller 60 to adjust the output level of the amplifier 58. The output signal level controller 60 includes a variable resistor network 62, which acts as a voltage divider, whose output is fed into a differential amplifier 64. The differential amplifier 64 converts a single-ended input to a balanced output pair, and an output impedance controller 66 controls the outputs of the differential amplifier 64 before being directed to the audio controller 17 via the tie line 24. Generally, output impedance controller 66 includes a plurality of resistive elements 68 or a mode select switch in series with the outputs of the differential amplifier 64, in order to control the output impedance of each bi-directional tie line. Typically, a universal ICS tie output includes an output impedance controller 66 that allows the selection of one of four ICS signal levels, as provided by four separate resistive elements. There may be of course be more resistive element choices available. The position of the mode select switch 68 is determined by an operator or may be performed automatically by a processor (not shown) included in the adapter 18. The input signal level controller 52 thus can adjust the analog output signal from the coupler 28 to a similar voltage range to that of the coupler 26, thereby providing to the codec 32 a signal in a common range to that provided to the codec 30. The output signal level controller 60 adjusts the analog output signal from the codec 32 into a signal in the range required for the audio controller 17 together with the matching impedance.

The functions of the codec 30 will now be described in detail. The output of the instrumentation amplifier 42 is introduced to the master codec 30, which converts the analog audio signals into digital audio signals. Generally, the analog audio signal is sampled using coding schemes such as A-law or μ-law to represent the analog audio signal as a discrete digital signal, such as pulse coded modulation (PCM) signal. The codec 30 output is interfaced to the DSP 34 via a digital serial link 36 which processes the digital signal as already described. Generally, the codecs 30 and 32 receive input signals, via the couplers 26 and 28, from a plurality of sources, such as, system audio, CD/DVD-ROM audio, microphone, speakerphone, stereo line_in, video and auxiliary input, and provide the corresponding digital input to the DSP 34. The codecs 30 and 32 also generate from the digital signals received from the DSP 34 an analog mono output or a stereo output to the speakers, headphones or line_out. In a preferred embodiment, the codec 30 or 32 is an AD 1819 codec from Analog Devices, MA, USA, although any other suitable codec may be used. The output of the instrumentation amplifier 42 constitutes an external audio source (line_in) into the codec 30. The codec 30 may be daisy-chained with other codecs, for example codec 32, to allow a number of codecs to be coupled to a single port of another device, such as, the master codec 30. If the codec 30 is used in an embedded audio application, the use of more codecs 32 permits the provision of more audio inputs and outputs for processing multiple signals concurrently.

As noted above, the codec 30 is interfaced with the DSP 34 via the digital serial link 36, which typically includes a 5-pin digital serial interface link. The digital serial link 36 is bi-directional and can handle multiple input and output audio streams of PCM digital signals from the codec 30. The DSP 34 includes an echo canceller 70 to generate an impulse response characteristic caused by the audio controller 17 coupled to the adapter 18. Therefore, the DSP 34 acts to cancel out any echoes which are within the digital signals, these echoes are generally caused by the opposite digital signal. The echo canceller 70 suppresses positive feedback on the transmission network 10, by predicting and subtracting a locally generated replica of the echo based on the signal propagating in the forward direction. Included in the DSP 34 are a plurality of filters to remove unwanted noise and also to improve the output signal quality, using techniques such as Fast Fourier Transforms (FFTs) and Hilbert transforms. In a typical embodiment, the DSP 34 is the AD2186 DSP device from Analog Devices, but may be any other suitable DSP device.

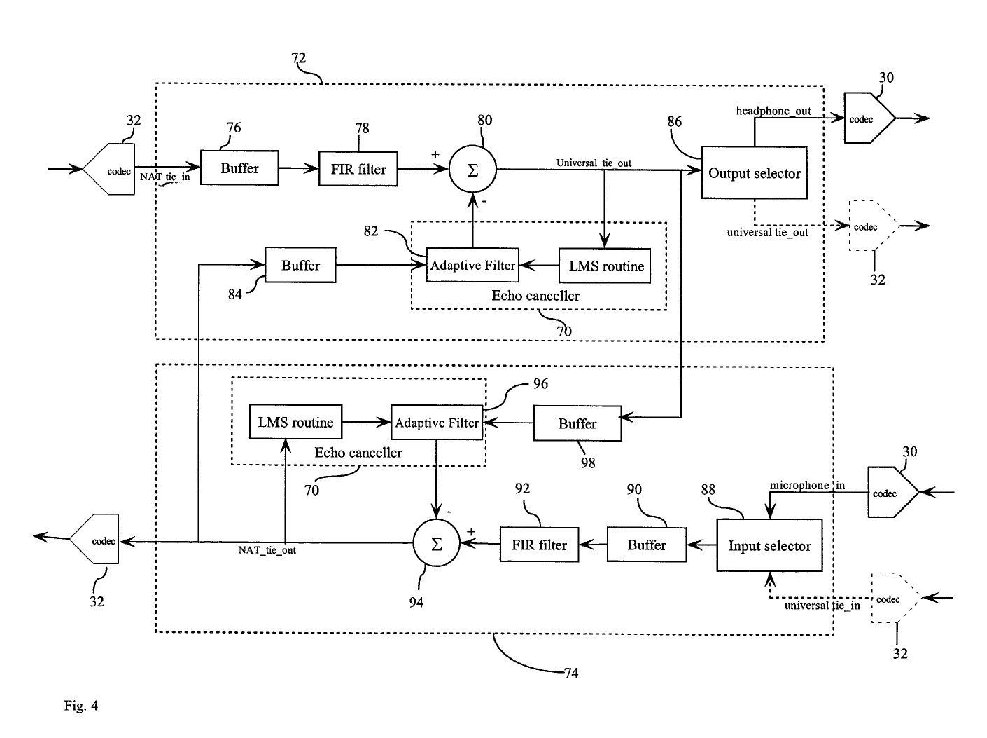

In order to support a NAT tie line, a microphone input and a headphone output, the input signal to the DSP 34 is processed as described below. Referring now FIG. 4, the DSP 34 includes a signal conditioner 72 for receiving a signal from the coupler 28 such as a NAT tie line signal, and a conditioner 74 for receiving a signal from the coupler 26. For example, a standard NAT tie line signal is input into the signal conditioner 72 from the codec 32 and buffered by a NAT tie line input buffer 76. Typically, the NAT tie line input buffer 76 is a 64-tap buffer which is used in co-operation with a finite impulse response (FIR) filter 78 to implement a 64 FIR filter routine with 64 coefficients or delay pairs. Generally, the number of taps may be more or less, depending on the amount of stopband attenuation required. After the FIR routine the filtered NAT tie line signal is fed into a mixer 80 and the output signal from the mixer 80 is split into two paths. One path undergoes an adaptive filter 82 routine by the echo canceller 70, while the other part is fed into the signal conditioner 74. The output from the echo canceller 70 is then subtracted by the mixer 80 in a feedback loop. Generally, the echo canceller 70 also employs algorithms such as the Least Mean-Square (LMS) algorithm to produce an output that closely resembles the noise in the input signal, such that the overall output is an optimal estimate of the input signal. Also, a NAT output signal from the second conditioner 74 is buffered by a buffer 84 and filtered by the adaptive filter 82. The output signal from the mixer 80 represents a universal tie line output signal which is then introduced to an output selector 86 to determine an output signal for the headphones 14. Thus, the universal tie line digital output signal, is then introduced into the codec 32 for conversion into an analog signal, which is processed by the coupler 26, as described above.

The signal conditioner 74 receives a signal from the second coupler 26, such as a microphone 12 input signal. The signal is input to the signal conditioner 74 via an input selector 88. For example, a microphone 12 input signal is buffered by a buffer 90, typically a

64-tap buffer in co-operation with a finite impulse response (FIR) filter 92. After the FIR routine the filtered universal tie line signal is fed into a mixer 94 and the output signal from the mixer 94 is split into two paths. One path undergoes an adaptive filter 96 routine by the echo canceller 70, while the other part is fed into the signal conditioner 72. The output from the echo canceller 70 is then subtracted by the mixer 94 in a feedback loop. Also, the universal tie line output signal from the first conditioner 72 is buffered by a buffer 98 and filtered by the adaptive filter 96. The digital output signal from the mixer 94 is then converted by a codec 32 into an analog signal to be processed by coupler 28.

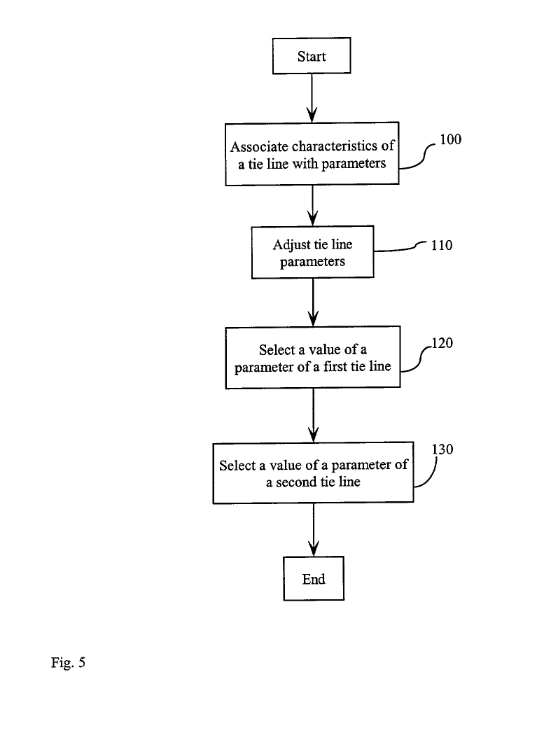

FIG. 5 is a flow chart showing a method for controlling a plurality of characteristics associated with an input device 12 and a tie line 24 to allow communication between devices 12 and 17. The method includes the steps of associating the characteristics with input and output parameters of each of the tie lines, in step 100, such as voltage, impedance and power, among others. The next step 110 involves adjusting the microphone 12 characteristics. The input characteristics of the microphone 12 input signal are adjusted by mode select switch 40 to a common selected range. Vice versa, the input characteristics of the tie line 24 input signal are adjusted by the mode select control switch 54 to the same common range. The step of adjusting the characteristics includes the further step, 120, of selectively choosing a value of at least one of the plurality of parameters of the microphone 12 characteristics to cause the value of the at least one of a plurality of parameters to substantially match a value of the at least one of the plurality of parameters of the tie line 24 characteristics. In another further step 130, a value of at least one of the plurality of parameters of the tie line 24 characteristics is selectively chosen to cause the value of the at least one of the plurality of parameter to substantially match a value of the at least one of the plurality of parameters of the microphone 12 characteristics. In the output stage of the coupler 26, the method includes the further step of adjusting the output impedance by the mode selector switch 50 to meet the requirements of the headphones 14. Vice versa, the output impedance is adjusted by the mode select control switch 68 to match the load impedance of the audio controller 17.

In a preferred embodiment, the adapter 26 includes adjustable input levels and adjustable output levels to match most commonly used configurations. The input and output level adjustments are set to achieve the best configuration match between the tie lines 18, 20 and 24.

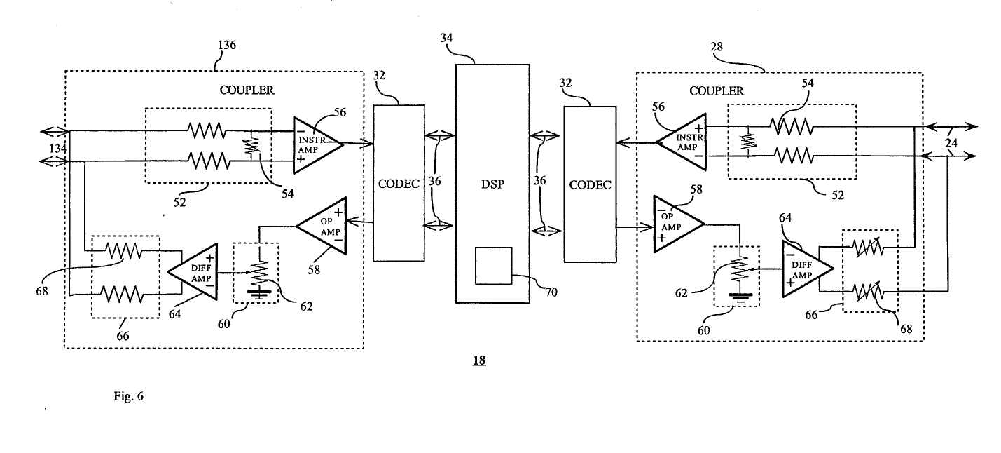

The above embodiment has been described with an audio panel 15 and an audio controller 17. In another embodiment, a first audio controller 17 and a second audio controller 132 are coupled together via an adapter 18, as shown in FIG. 6. As a example, the first audio controller 17 is an AMS43 Audio Controller from Northern Airborne Technology (NAT), British Columbia, Canada, which has a NAT-standard bi-directional intercom tie line 24 of 340 mV_{RMS} and expected impedance of 2000 Ohms. The second audio controller 132 is a dB 355-003 Audio Controller from dB Systems, Washington, USA, which has a bi-directional intercom tie line 134 of 800 mV_{RMS} and expected impedance of 300 Ohms. Therefore, these two audio controller 17 and 132 may not be directly interfaced together to achieve desirable communication, due to the different input and output characteristics. In this case, the first audio controller 17 is coupled to the adapter 18 via the standard NAT tie line 24 while the second audio controller 132 is coupled to the adapter 18 via a universal tie line 134, as described below. The universal tie line 134 allows audio controller 17 and 132 with different tie line characteristics to be interfaced together to facilitate communication therebetween.

The audio controllers 17 and 132 are connected to the adapter 18 via couplers 28 and 136. The coupler 136 is substantially identical to the coupler 28, thus in the drawings like parts are represented by the same numerals. Therefore, the input characteristics of the tie line 24 are adjusted to substantially match the output characteristics of the tie line 134, and vice versa. The adapter 18 thus allows upgrades and additions of audio systems to an existing audio system, interfacing directly to their proprietary bi-directional or uni-directional ICS tie lines 24 and 134. The adapter 18 offers the convenience and flexibility to interface dissimilar audio systems such as Gemelli, Telephonics, Andrea, dB Systems, Honeywell, and Team. For example, the Gemelli AG-06-1U5 universal tie line has the following input and output characteristics: 400 mV_{RMS} into a load of 430 Ohms: the Telephonics universal tie line: 400 mV_{RMS} into a load of 150 Ohms, the Andrea A301A-6W universal tie line: 2.8 V_{RMS} into a load of 600 Ohms and the Honeywell universal tie line: 7.7 V_{RMS} into a load of 600 Ohms. Typically, a universal ICS tie input and output includes the selection of one of four ICS signal levels, as provided by four separate resistive elements. There may be of course be more resistive element choices available.

In order to support a NAT tie line signal and the universal tie line signal, DSP 34 processes the signal as described above, with reference to FIG. 4, in which the universal tie line input and the universal tie line output are shown in a ghosted outline. The input selector 88 thus selects universal tie line input signal from codec 32 and the output selector 86 selects the universal tie line output signal for input to codec 32.

In another embodiment, the audio controller 17 and 132 are manufactured by the same original equipment manufacturer (OEM), so that the two audio controller 17 and 132 have the same tie line characteristics, hence no adjustments are necessary. In such a case, the tie lines 24 and 134 would be automatically matched and the two audio controllers 17 and 132 can interoperate.

In another embodiment, a unidirectional tie line with separate input and output interconnects is also supported by the adapter 18.

In another embodiment, a low-impedance microphone is connected directly to an unbalanced low-impedance input, but the noise-cancelling benefit will be lost.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. An tie line adapter for use with a first communication system and a second communication system, said first communication system having a tie line with a first characteristic and said second communication system having a tie line with a second characteristic, said tie line adapter having a first controller for controlling said first characteristic, a second controller for controlling said second characteristic, wherein said first characteristic and said second characteristic are adjusted to substantially match each other to allow communication between said first communication system and second communication system.

2. The line adapter of claim 1, wherein said communication between said first communication system and second communication system is bi-directional.

3. The line adapter of claim 1, wherein said communication between said first communication system and second communication system is uni-directional.

4. The line adapter of claim 1, wherein said first characteristic and said second characteristic include a plurality of input parameters and output parameters.

5. The line adapter of claim 4, wherein said first controller includes a mode select switch for selectively choosing a value of at least one of a plurality of parameters of said first tie line characteristics to cause said value of said at least one of a plurality of parameters to substantially match a value of said at least one of a plurality of parameters of said second tie line characteristics.

6. The line adapter of claim 4, wherein said second controller includes a mode select switch for selectively choosing a value of at least one of a plurality of parameters of said second tie line characteristics to cause said value of said at least one of a plurality of parameter to substantially match a value of said at least one of a plurality of parameters of said first tie line characteristics.

7. The line adapter of claim 4, wherein said first controller includes a mode select switch for selectively choosing a value of at least one of a plurality of parameters of said first tie line characteristics to cause said value of said at least one of a plurality of parameters to substantially match a value of said at least one of a plurality of parameters of said second tie line characteristics and said second controller includes a mode select switch for selectively choosing a value of at least one of a plurality of parameters of said second tie line characteristics to cause said value of said at least one of a plurality of parameter to substantially match a value of said at least one of a plurality of parameters of said first tie line characteristics.

8. The line adapter of claims 5, 6 and 7, wherein said at least one of said plurality of input parameters is voltage.

9. The line adapter of claims 5, 6 and 7, wherein said at least one of said plurality of input parameters is impedance.

10. The line adapter of claims 5, 6 and 7, wherein said at least one of said plurality of output parameters is voltage.

11. The line adapter of claims 5, 6 and 7, wherein said at least one of said plurality of output parameters is impedance.

12. The tie line adapter of claims 5, 6 and 7, wherein said first controller comprises an input signal level controller and an input impedance controller for controlling input impedance into said adapter.

13. The tie line adapter of claims 5, 6 and 7, wherein said second controller comprises an output signal level controller and an output impedance controller for controlling the output impedance of said adapter.

14. A method for controlling a plurality of characteristics associated with a first tie line and a second tie line to allow communication between a pair of devices, said method including the steps of:
associating said characteristics with input and output parameters of each of said tie lines; and
adjusting said input parameter of said first tie line and adjusting said output parameters of the second tie line such that there is a substantial match between said characteristics of each of said tie line to facilitate efficient power transfer between said devices, said step of adjusting including the further steps of:
selectively choosing a value of at least one of a plurality of parameters of said first tie line characteristics to cause said value of said at least one of a plurality of parameter to substantially match a value of said at least one of a plurality of parameters of said second tie line characteristics; and
selectively choosing a value of at least one of a plurality of parameters of said second tie line characteristics to cause said value of said at least one of a plurality of parameter to substantially match a value of said at least one of a plurality of parameters of said first tie line characteristics.

15. The method of claim 14, wherein said at least one of said plurality of input parameters is voltage.

16. The method of claim 14, wherein said at least one of said plurality of input parameters is impedance.

17. The method of claim 14, wherein said at least one of said plurality of output parameters is voltage.

18. The method of claim 14, wherein said at least one of said plurality of output parameters is impedance.
